(19) United States
(12) Patent Application Publication
(10) Pub. No.: US 2012/0125718 A1
(43) Pub. Date: May 24, 2012

(54) ACTIVATION OF AN ELEVATOR INSTALLATION OPERATING UNIT

(76) Inventor: Beniamino Demma, Glublasco (CH)

(21) Appl. No.: 13/321,638

(22) PCT Filed: May 20, 2010
(86) PCT No.: PCT/EP10/56962

§ 371 Date: Jan. 19, 2012

(30) Foreign Application Priority Data
May 20, 2009 (EP) 09160812.5

(51) Int. Cl. B66B 1/14

(52) U.S. Cl. 187/380

(57) ABSTRACT

A device and a method activates at least one operating unit of an elevator system, the operating unit or units having at least one switching element, a control unit and a switch element. The operating unit or units is or are connected to a controller via a communication network and the unit or units is or are located on a floor. The operating unit or units has or have a circuit for bypassing the switch element.

### FIELD OF THE INVENTION

The invention relates to a device, a method and an operating unit for activation of an operating unit of an elevator installation.

### BACKGROUND OF THE INVENTION

Elevator installations after they have been installed or significant repair measures have been undertaken have to be checked or tested. In particular, after an elevator installation has been installed placing in operation is necessary, in which many parameters have to be set and a comprehensive and detailed check of the individual components of the elevator installation is carried out. A number of method steps has to be performed, which have to be carried out after the installation of all mechanical parts and all electrical components so as to transfer the installation to a state enabling normal operation. Belonging to the necessary method steps of placing in operation are, inter alia, a check of the mechanical and electrical requirements, an activation of the electrical components, a check of the drive, the configuration of shaft information for determination of the position and speed of the elevator car and the configuration of an elevator control as well as a device for measuring the car load and the communications interfaces. A good example of such a method is known from EP 0366097 A1.

A further check consists of testing whether the elevator car stops at a floor if prior to this floor the elevator was called by means of an operating unit. For that purpose the elevator engineer has to go from floor to floor, actuate the operating unit and check for correct stopping of the elevator car. This check is connected with substantial physical strain for the elevator engineer. Moreover, such a manual check requires a considerable amount of time, which unnecessarily increases costs for the installing.

### SUMMARY OF THE INVENTION

It is an object of the invention to propose a possibility for a cost-effective and efficient checking of an elevator installation.

A core of the invention consists in that for activation of an operating unit of an elevator installation in a building comprises several floors the switch unit is bridged over by an elevator operating unit. In that case, the elevator installation comprises at least one elevator car which moves along a vertical car travel path between the floors, a control unit and, on floors at which the elevator car stops, at least one operating unit connected with the control unit by way of a communications network. The activation of the operating unit can thus be carried out centrally by a control unit for test purposes. However, an activation of that kind could also be required for emergency scenarios. Finally, it is also conceivable for the activation of the operating unit to take place for the purpose of a normal elevator journey.

The at least one operating unit includes at least one switching element, for example a pushbutton, a rocker switch, a touch-sensitive sensor, a capacitive sensor, an inductive sensor, etc., a controlling unit, for example a microcontroller, and a switch unit, for example a switch logic system, etc. Any form of operating unit can be used as operating unit. Thus, for example, operating units with inductive, capacitive, electronic, mechanical and electrical switching elements can be used.

The circuit is so constructed that it allows bridging over of the switch unit and can in that case comprise at least one transistor.

In the case of a capacitive switch or operating unit the base of the transistor is connected with the output of the controlling unit of the operating unit and the emitter is connected with ground. The collector of the transistor is connected with the switching element of the operating unit by way of a capacitor connected in series. In the case of a mechanical or electrical or also electronic switch the base of the transistor is connected with the output of the controlling unit of the operating unit, the collector is connected with the switching element and the emitter is connected with ground.

Any form of communications network such as, for example, a packet-switching communications network, a circuit-switching communications network, a radio network, a bus system, etc., can be used as communications network. If the control unit of the elevator installation transmits a signal to the at least one operating unit, then the circuit is activated. The activation of the circuit can also be carried out at the same time with any operating unit of the elevator installation. The control unit in that case transmits an activation signal at the same time to all operating units of the elevator installation. A procedure of that kind is usually termed group call or broadcast. The signal can in that case be an analog signal, a digital signal, a current pulse, a signalling communication, etc. The form of signal substantially depends on the processing possibilities of the operating unit. According to the invention the signal for activation of the circuit is received by the controlling unit and this activates the circuit. The switch unit of the operating unit is thus bridged over.

The activation of the circuit has the consequence that pressing of the switching element is simulated. The signal created through the simulated pressing of the switching element, for example an item of data, a current pulse, an analog signal, a digital signal, etc., is detected or received by the switching unit and passed onward to the controlling unit. The controlling unit evaluates the signal in certain circumstances and reports the pressing of the switching element to the control unit for further processing. The signal received by the control unit is to trigger the effect that the elevator car moves towards the floor at which the switching element of the operating unit was subjected to simulated pressing, stops at the floor and opens the doors so that a notional (only a simulated pressing of the operating unit is present) user of the elevator installation at this floor can undertake an elevator journey. According to the invention it can thus be checked whether the elevator installation is correctly configured and correct operation is ensured.

An advantage of the invention is to be seen in that the physical loading of service employees, engineers, etc., can be significantly reduced.

A further advantage is that the functioning of the operating unit and the configuration of the elevator installation can be tested during a test procedure.

### DESCRIPTION OF THE DRAWINGS

The invention is explained in more detail on the basis of an exemplifying embodiment illustrated in the figures, in which:

FIG. 1 shows a simplified schematic illustration of an elevator installation in a building;

FIG. 2 shows a capacitive switch according to the invention; and

FIG. 3 shows a mechanical switch.

### DETAILED DESCRIPTION OF THE INVENTION

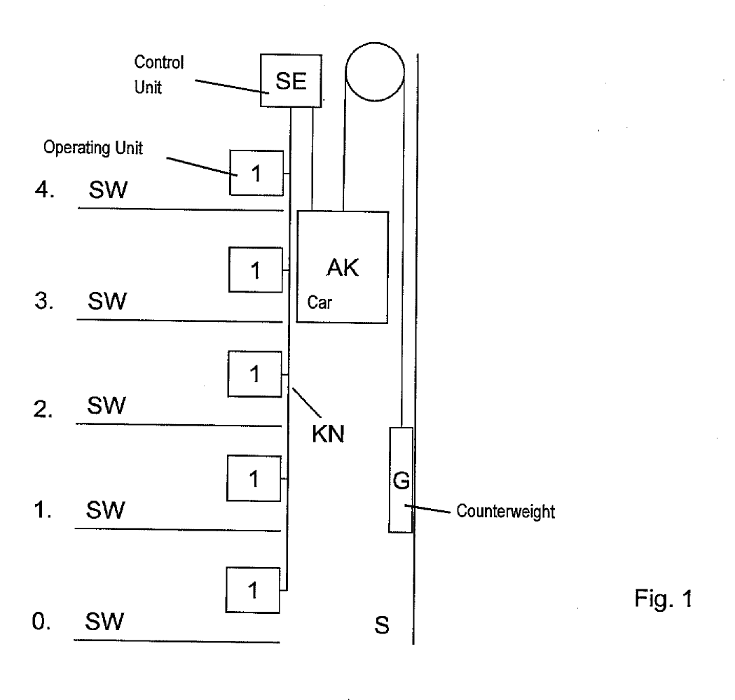

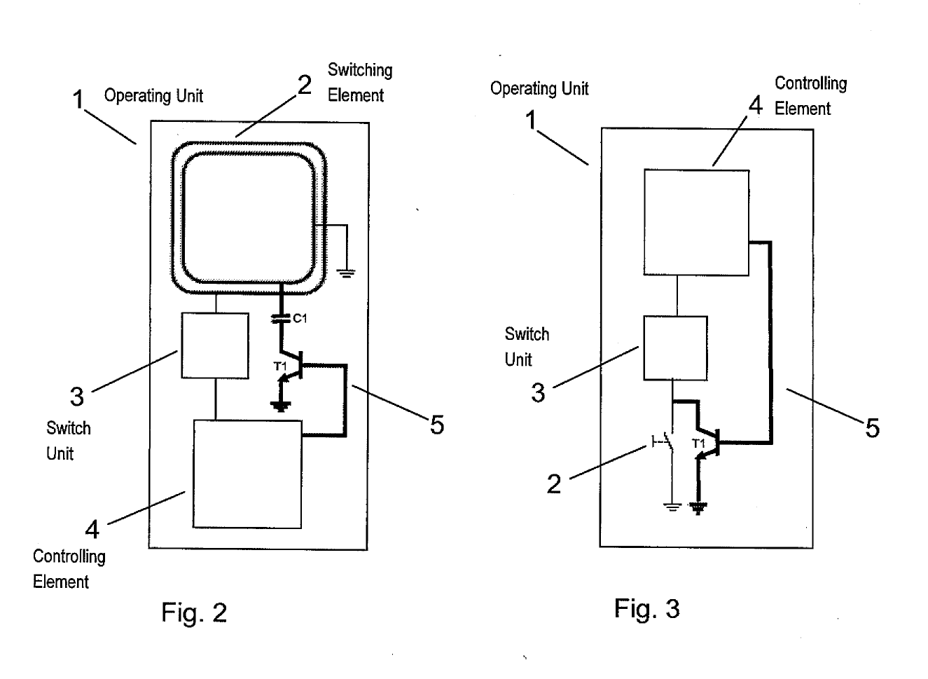

FIG. 1 shows a simplified schematic illustration of an elevator installation in a building. In this example the building has several floors SW (0 to 4th floor) and an elevator shaft S, in which the elevator installation is installed. The elevator installation consists at least of an elevator car AK, at least one control unit SE and operating units 1, which are arranged on each floor to which a journey can be made. The operating units 1, which, as shown in FIG. 2, comprise at least one switching element 2, switch unit 3, controlling unit 4 and the circuit 5 according to the invention, are connected with the control unit SE by way of a communications network KN. The elevator car AK similarly comprises operating and control units, which are connected with the control unit SE by way of a communications network KN. However, for reasons of clarity these are not illustrated. In addition, the drive and further units of the elevator installation are not illustrated for the same reason.

In the present elevator installation, a classic elevator installation with a counterweight G connected by way of a cable system with the elevator car AK is illustrated. The type or kind or mode of construction of the elevator installation is of no significance for the method or device according to the invention. Thus, the method or device according to the invention could also be used, for example, with an elevator installation with a hydraulic, pneumatic, magnetic, etc., basis.

In order to check the elevator installation a signal is sent by the control unit SE to at least one operating unit 1 for activation of the bridging-over of the switch unit 3 of the at least one operating unit 1. The controlling unit 4 of the operating unit 1 activates the bridging-over of the switch unit 3 and thus pressing of the switching element 2 is simulated. The simulated pressing of the switching element 2 generates a signal which is passed on by way of the switch unit 3 to the controlling unit 4. The controlling unit 4 transmits to the control unit SE the signal that the switching element was (in simulation) pressed. The control unit SE on the basis of the received signal triggers the event that the elevator car shall move to the floor SW at which the switching element 2 of the operating unit 1 was pressed in simulation, stop at the floor SW and open the doors so that a notional (only a simulated pressing of the operating unit is indeed present) user of the elevator installation could or can carry out an elevator journey. According to the invention it is checked by this procedure whether the elevator installation is correctly configured and a correct operation is guaranteed.

FIG. 2 shows the schematic construction of a capacitive switch. Capacitive switches or capacitive sensors are generally based on the principle that two plates form an electrical capacitor, of which one is displaced or deformed by the effect to be measured. The plate spacing thereby changes and thus the electrically measurable capacitance. The change in capacitance can also be produced, for example, by a change in an electrically conductive material in the vicinity of the switch.

The operating unit 1 thus comprises at least one switching element 2, switch unit 3, controlling unit 4 and a circuit 5 according to the invention. The operating unit 1 also comprises a receiving unit and a transmitting unit for reception of signals and transmission to the control unit SE, which for reasons of clarity was not illustrated. In this example the circuit 5 comprises at least one transistor T1 which is connected by way of the base with the controlling unit 4. The emitter of the transistor T1 is connected with ground and is thus earthed. The collector of the transistor T1 is connected with the switching element 2, wherein a capacitor C1 is connected in series between this connection. The switch unit 3 can be bridged over by the circuit 5. As circuit 5 according to the invention use can in principle be made of any circuit enabling bridging-over of the switch unit 3. In the case of an activation signal from the control unit SE, the controlling unit 4 activates the circuit 5. Pressing of the switching element 2 is thereby simulated, which is reported by way of the switch unit 3 and the controlling unit 4 to the control unit SE. The check according to FIG. 1 can thus be performed.

FIG. 3 shows the schematic construction of a mechanical switch. By “mechanical switch” there is meant that the switching element 2 of the operating unit 1 represents a mechanical switching element 2. The operating unit 1 thus comprises at least one mechanical switching element 2, for example a pushbutton, a rocker switch, etc., a switch unit 3, a controlling unit 4 and a circuit 5 according to the invention. The circuit 5 in this example comprises a transistor T1, the base of which is connected with the controlling unit 4. The emitter of the transistor T1 is connected with ground, thus earthed. The collector of the transistor T1 is so connected with the switching element 2 that the switch unit 3 can be bridged over. Other possibilities for bridging over the switch unit 3 in accordance with the invention are obviously also conceivable. It only has to be ensured that in the case of an activation signal from the control unit SE a simulated pressing of the switching element 2 can take place. If the activation signal from the control unit SE takes place, the method according to FIG. 1 is set in operation.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A device for activating at least one operating unit of an elevator installation, the at least one operating unit comprising:
at least one switching element;
a controlling element;
a switch unit connected between the at least one switching element and the controlling element wherein the at least one operating unit is connected with an elevator control unit by a communications network and wherein the at least one operating unit is arranged at a floor; and
a circuit connected between the at least one switching element and the controlling element for bridging over the switch unit.

13. The device according to claim 12 wherein the at least one switching element is one of an inductive switching element, a capacitive switching element, an electronic switching element, a mechanical switching element and an electrical switching element.

14. The device according to claim 12 wherein the circuit includes a transistor.

15. The device according to claim 14 wherein the at least one switching element is a capacitive switching element and the transistor has a base connected with the controlling unit, an emitter connected with ground and a collector connected with the switching element through a capacitor.

16. The device according to claim 14 wherein the at least one switching element is a mechanical switch and the transistor has a base connected with the controlling unit, a collector connected with the mechanical switch and an emitter connected with ground.

17. The device according to claim 12 including a communications network connected to the at least one operating unit and the communications network is one of a packet-switching communications network, a circuit-switching communications network, a radio network and a bus system.

18. The device according to claim 12 including a control unit that transmits to the at least one operating unit a signal for activation of the circuit.

19. The device according to claim 18 wherein the control unit transmits the signal to all operating units of the elevator installation at the same time.

20. The device according to claim 18 wherein the controlling unit receives the signal and activates the circuit.

21. An operating unit for an elevator installation comprising:
a controlling element;
a switch unit connected to the controlling element;
a switching element connected to the switch unit; and
a circuit connected to the controlling element and the switching element and bridging over the switch unit.

22. A method of activating at least one operating unit of an elevator installation comprising the steps of:
providing the at least one operating unit with at least one switching element, a controlling unit, a switch unit connected between the at least one switching element and the controlling unit, and a circuit connected between the at least one switching element and the controlling unit wherein the at least one operating unit is arranged at a floor of the elevator installation;
connecting the at least one operating unit with a control unit by a communications network; and
operating the circuit to bridge over the switch unit.
